(19) United States
(12) Patent Application Publication
(10) Pub. No.: US 2007/0286700 A1
(43) Pub. Date: Dec. 13, 2007

(54) Self-Threading Female Fastener Elements and Method of Forming Same

(76) Inventor: Harold A. Ladouceur, Livonia, MI (US)

Correspondence Address: Howard & Howard Attorneys, 39400 Woodward Avenue, Suite 101, Bloomfield Hills, MI, 48304-5151, US

(21) Appl. No.: 11/578,807

(22) PCT Filed: Nov. 24, 2003
(86) PCT No.: PCT/US03/37534

§ 371 Date: Feb. 23, 2007

Related U.S. Application Data
(60) Provisional application No. 60/431,003, filed on Dec. 5, 2002.

(51) Int. Cl. F16B 37/00; B23P 17/00; B23P 17/04

(52) U.S. Cl. 411/333; 29/412; 29/592

(57) ABSTRACT

A female fastener having a self-threading bore for threaded receipt of a conventional male threaded fastener which forms a substantially continuous female thread without tapping having a prevailing torque. The bore includes a cylindrical internal surface and a plurality of circumferentially spaced concave recesses having a total volume equal to an annulus defined by a major diameter and an inner diameter of the cylindrical surface. A method of forming self-attaching fasteners by rolling a continuous metal strip having a central pilot, piercing spaced self-threading bores through the pilot and either severing the pilot or the strip. Where the strip is severed into discreet fasteners, the fasteners may be interconnected by a frangible connector without reorienting the fasteners.

### FIELD OF THE INVENTION

This invention relates to fastener elements having a self-threading or self-tapping bore upon receipt of a standard or conventional spirally threaded male fastener element formed by piercing a configured bore through the female fastener element which forms a continuous spiral female thread upon threaded receipt of a conventional spirally threaded male fastener element, such as a screw or bolt. The self-threading female fastener element of this invention also provides prevailing torque. This invention also relates to a method of forming self-attaching female fastener elements having a self-threading bore.

### BACKGROUND OF THE INVENTION

The prior art includes self-threading and thread rolling male fastener elements, including bolts and screws, which form a spiral thread in a cylindrical bore of a female fastener element, including nuts. However, such self-threading or thread rolling male fastener elements are relatively expensive and therefore are not widely used in mass production applications. The prior art also includes bolts and screws having prevailing torque which generally include a lobular cross-section. As will be understood, the term “prevailing torque” means that the torque required to thread the male fastener element into the female fastener element is maintained, generally at decreasing levels, with each removal and rethreading of the male fastener element into the female fastener element. Conventional male and female fastener elements have a clearance between the threads, such that the female fastener element can be unthreaded under vibrational loads, for example. However, male fastener elements having prevailing torque are generally relatively expensive to manufacture and are therefore used only in applications requiring prevailing torque.

The prior art also includes female fastener elements generally formed from strip steel having a stamped opening which threadably receives a male fastening element, such as a screw. The “Tinnerman” fasteners are typical of this type of fastener. However, the prior art does not include commercial female fastener elements, such as conventional nuts, including self-attaching nuts, having a self-threading bore which may be pierced through the body portion of the female fastener element and which provide prevailing torque.

As will be understood by those skilled in this art, a substantial portion of the cost of a conventional female fastener element is the cost of forming or tapping the threaded bore. In a conventional nut, for example, a cylindrical bore is first pierced through the nut body and the bore is then tapped forming a continuous spiral female thread requiring expensive tapping machines and handling equipment. A chamfer or counter bore is often required to reduce burrs and provide a lead in for the screw, bolt or male fastener element. The tapping operation is generally the slowest step in the manufacture of conventional female fastener elements and the tapping tool must continuously be lubricated with oil, such that the female fastener elements must be cleaned after tapping of lubricating oil, chips and burrs. Thus, in a typical application, the female fastener elements must be taken “off line” to a tapping machine which forms the female thread and cleaned following tapping. Because the tapping operation is generally the slowest step in the manufacture of female fastener elements, several expensive tapping machines are generally utilized by the manufacturer of female fasteners to maintain a continuous manufacturing operation.

The problems associated with tapping female fastener elements described above are a particular problem with the manufacture of self-attaching female fastener elements including pierce, clinch and weld nuts. For example, the self-attaching female fastener elements disclosed in U.S. Pat. Nos. 3,187,796, 3,648,747 and 3,711,931, all assigned to the assignee of the predecessor in interest of the assignee of the present application, are formed by rolling a continuous metal strip having the desired cross-section of the female fastener elements, including a continuous projecting pilot portion and flange portions on opposed sides of the pilot portion. The rolled strip is then pierced forming a cylindrical bore. The rolled strip is then severed or chopped, forming discreet self-attaching female fastener elements, and the cylindrical bore is then tapped by tapping machines forming a continuous spiral female thread in the bore for receipt of a male fastener element, such as a bolt, following installation in a panel. The pierce or clinch nuts disclosed in these patents have achieved substantial commercial success, particularly in mass production applications used by the automotive and appliance industries. However, the thread tapping operation is much slower than the other manufacturing steps, requiring several expensive high speed tappers, labor and time.

Where the self-attaching female fastener elements disclosed in the above-referenced patents are interconnected in a strip for feeding to the fastener installation head, as disclosed in the above-referenced U.S. Pat. No. 3,711,931, the fastener elements are collected in a hopper following severing of the strip and transferred to tapping machines as described above. Following tapping and cleaning of oil, chips and burrs, the self-attaching female fasteners are then reassembled in end to end relation and interconnected by frangible connector elements. Thus, the tapping operation significantly slows the manufacture of self-attaching female fastener elements as disclosed in this patent and increased labor and time. Reference is also made to U.S. Pat. Nos. 3,775,791 and 3,999,659, wherein the fastener elements remain integral with the strip, requiring a gang tapping operation, which also slows the manufacturing process and wherein the taps must be periodically replaced or sharpened and the strip must be cleaned of chips, oil and burrs.

There is, therefore, a long felt need for a female fastener element, such as a nut, having a self-threading bore, wherein the bore may be formed by piercing, thereby eliminating the tapping operation, and which may be utilized with standard male fastener elements, including conventional bolts and screws. The self-threading or self-tapping female fastener elements of this invention eliminate the tapping operation in the manufacture of female fastener elements, thereby significantly reducing the cost and providing further advantages including a prevailing torque female fastener element.

### SUMMARY OF THE INVENTION

The self-threading female fastener element of this invention is adapted for receipt of a conventional or standard spirally threaded male fastener element, such as a conventional bolt or screw. The female fastener element of this invention includes a metal body portion having a configured bore therethrough, wherein the bore includes a generally cylindrical internal surface or more specifically equally circumferentially spaced cylindrical surfaces having a diameter less than the major or crest diameter of the male fastener element. In a preferred embodiment, the internal diameter of the cylindrical surface or surfaces is approximately equal to the minor or root diameter of the male threaded element. The bore of the female fastener element further includes a plurality of equally circumferentially spaced recesses between the cylindrical surfaces, wherein threading of a male fastener element into the bore deforms metal from the cylindrical surface or surfaces into the recesses forming a substantially continuous female spiral thread. Because the threads of the male fastener element and the threads formed in the female fastener element are in line to line contact, unlike a conventional nut and bolt wherein the threads of the male and female fastener are spaced, the female fastener element of this invention also provides prevailing torque.

In one preferred embodiment of the self-threading female fastener element of this invention, the recesses in the generally cylindrical internal surface are cylindrical concave surfaces and the bore includes an inlet portion wherein the generally cylindrical surface is frustoconical, providing a lead-in for a male fastener element and reducing or eliminating burrs formed during threading of the male fastener element into the self-threading female fastener element. To assure formation of a substantially full female spiral thread in the female fastener element, the total volume of the recesses are approximately equal to an annulus defined by a major diameter of the bore measured between a radial outer surface of opposed recesses and an internal diameter of the generally cylindrical surface less the total volume of the recesses, such that the volume of each recess is approximately equal to the volume of the adjacent annular portion including the cylindrical surface defining the minor diameter of the bore. As will be understood, however, the volume of the adjacent annulus which is deformed into the recess is preferably slightly less than the recess to prevent binding of the male fastener element in the self-threading bore during threading. In a preferred embodiment, the volume of the annulus, as defined above, adjacent each recess is between eighty percent and ninety-five percent of the total volume of the recesses, providing a substantially fully formed continuous spiral female thread and prevailing torque. Cylindrical recesses are preferred with smaller female fastener elements, such as an M6 nut. However, it is believed that other shapes of recesses may be utilized, particularly for larger female fastener elements, including arcuate including concave rectangular recesses.

The method of forming a continuous strip of self-attaching female fastener elements of this invention provides additional benefits, particularly where the nut bodies are continuously formed in a rolling mill and the fastener elements are reconnected in the same orientation by frangible connector elements as described above. This method includes rolling a metal strip having a cross-section of the female fastener elements, including a continuous projecting pilot portion having an end face and parallel side faces and continuous flange portions on opposed sides of the continuous pilot portion. The method then includes piercing equally spaced configured bores through the end face of the continuous pilot portion of the strip having the self-threading configuration described above. The pilot portion may then be severed but retained in a strip having integral carrier portions as disclosed in the above-referenced U.S. Pat. Nos. 3,775,791 and 3,999,659 or the strip may be severed forming aligned discreet self-attaching fastener elements ready for interconnection with frangible connector elements if desired. In either embodiment, the tapping operation is eliminated.

The method of forming self-attaching female fastener elements of this invention has further advantages where the fastener elements are interconnected by a frangible connector element eliminating the requirement for taking the fastener elements off line for tapping as described above. The method of this invention may then include severing the strip between the self-threading bores, forming discreet female fastener elements and then interconnecting the discreet fastener elements with a frangible connector element without the requirements of tapping, cleaning and realignment. Thus, the orientation of the discreet female fastener elements may be maintained following severing of the strip and reconnecting the discreet fastener elements with a frangible connector element.

Other advantages and meritorious features of the self-threading female fastener element and method of this invention will be more fully understood from the following description of the preferred embodiments, the appended claims and the drawings, a brief description of which follows.

### BRIEF DESCRIPTION OF THE DRAWINGS

FIG. 1 is a top elevated view of a conventional nut having the self-threading bore of this invention;

FIG. 2 is a top view of self-threading nut shown in FIG. 1;

FIG. 3 is a side cross-sectional view of FIG. 2 in the direction of view arrows 3-3;

FIG. 4 is a side partially cross-sectioned view of a conventional threaded bolt;

FIG. 5 is a top view of a self-attaching female fastener element having a self-threading bore of this invention illustrating an alternative embodiment of a female fastener element;

FIG. 6 is a side cross-sectional view of FIG. 5 in the direction of view arrows 5-5;

FIG. 7 is a partially schematic top elevation illustrating a method of forming a self-attaching female fastener strip of this invention;

FIG. 8 is a top cross-sectional schematic view of a female fastener element having the self-threading bore of this invention during receipt of a conventional male threaded element;

FIG. 9 is a cross-sectional view of FIG. 8 in the direction of view arrows 9-9;

FIG. 10 is a top cross-sectional schematic view similar to FIG. 8 during forming of a spirally threaded bore in the self-threading bore of a female fastener element; and

FIG. 11 is a cross-sectional view of FIG. 10 in the direction of view arrows 11-11.

### DESCRIPTION OF THE PREFERRED EMBODIMENTS

As set forth above, the female fastener element and method of this invention is particularly, but not exclusively adapted for mass production applications and eliminates the requirement for threading or tapping the bore of the female fastener element and cleaning of chips and cutting oil. As will be understood from the following description of forming a substantially continuous spiral thread in the configured pierce bore of a female fastener element, a force is required to thread a male fastener element into the configured pierced configured bore of the female fastener element, such as utilized in mass production applications, wherein a torque power driver or wrench is utilized to thread either a female fastener element on a conventional male fastener element or a male fastener element into the bore of the female fastener element. Further, because the spirally threaded bore formed in the female fastener element during threading of a male fastener element into the pierced bore of the female fastener element is in line-to-line contact, the female fastener element of this invention additionally provides prevailing torque.

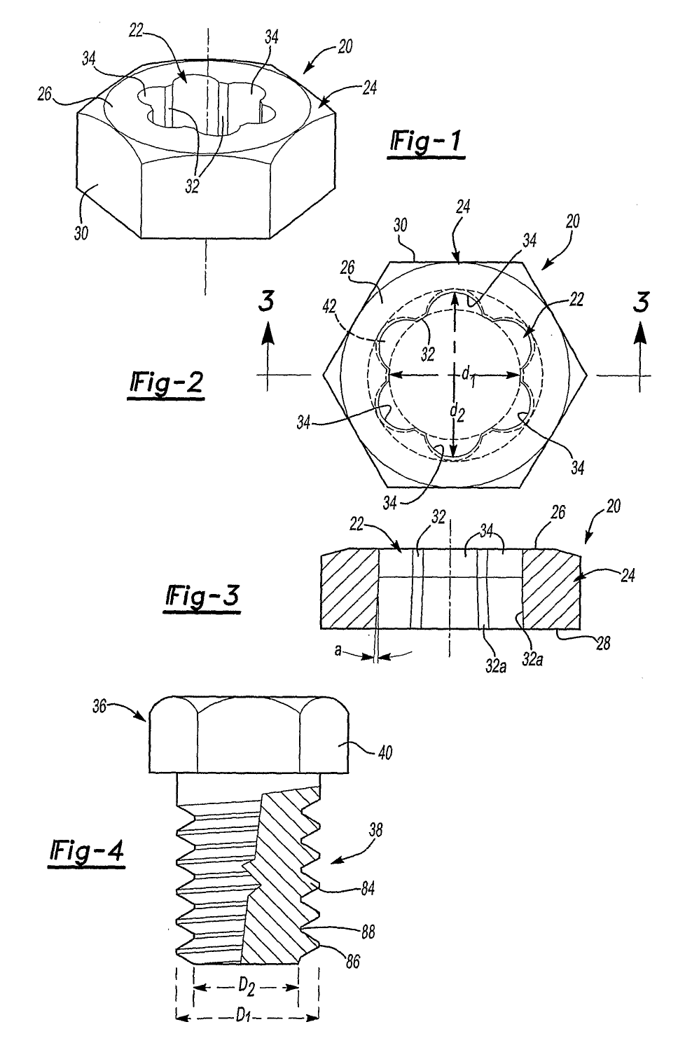

FIGS. 1 to 3 illustrate one embodiment of a female fastener element 20 of this invention having a configured pierced self-threading or self-tapping bore 22. The female fastener element 20 illustrated in FIGS. 1 to 3 has a conventional body portion 24 including a first end face 26, a second end face 28 and a hexagonal side face 30, wherein the configured pierced self-threading bore 22 extends through the end faces 26 and 28. As will be understood from the following description of the female fastener element and method of this invention, the configuration of the body portion 24 of the female fastener element 20 may be any conventional female fastener element, including fastener elements having any number of side faces suitable for threading the female fastener element on a conventional or standard male fastener element, wherein either the nut or bolt is fixed or restrained. The self-threading nut of this invention is also particularly suitable for weld nuts or weld studs. Further, as described below, the female fastener element and method of this invention is particularly suitable for self-attaching or welded female fastener elements.

The pierced configured bore 22 of the female fastener element 20 of this invention includes a generally cylindrical internal surface 32 having a plurality of spaced recesses 34. Stated another way, the internal surface 32 of the configured bore includes a plurality of equally circumferentially spaced cylindrical surfaces 32 spaced by concave recesses 34. As shown in FIG. 2 and described in more detail hereinbelow, the internal diameter d₁ of the cylindrical internal surface 32, which is the minor diameter of the configured pierced self-threading bore 22, is less than the major or crest diameter D₁ of the bolt 36 which is threaded into the bore 22 of the female fastener element 20 shown in FIG. 4. In a preferred embodiment, the minor diameter d₁ is approximately equal to but less than the minor diameter D₂ of the threaded shank 38 of the bolt 36 and the major diameter d₂ measured between the radial outer surfaces of opposed recesses 34 as shown in FIG. 2 is generally equal to but preferably slightly greater than the major diameter D₁ of the threaded shank portion 38 of the bolt 36 shown in FIG. 4. The bolt 36 shown in FIG. 4 is a conventional bolt having a hexagonal head portion 40 and a conventional threaded shank portion 38. As will be understood from the following description of forming a continuous female thread in the pierced bore 22 of the female fastener 20, the male threaded fastener element received in the female fastener element may be any conventional male threaded element, including but not limited to a conventional bolt or screw, but should be harder than the female fastener element, having a hardness for a Class 8.8 fastener or greater.

In one preferred embodiment, the generally cylindrical interval surface or surfaces 32 between the recesses 34 includes a frustoconical lead-in surface 32a as shown in FIG. 3, wherein the angle “a” is equal to approximately three degrees or between two and six degrees. Stated another way, the included angle of the frustoconical surface 32a is equal to approximately six degrees or between four and twelve degrees. As will be understood by those skilled in this art, the frustoconical surface 32a may be formed by piercing the self-threading bore 22 through the end face 26, wherein approximately one-third of the bore adjacent the pierced surface 26 is cylindrical and the remaining two-thirds include a desired break-out angle which may be accurately controlled. The frustoconical surfaces 32a thereby provide a lead-in for the bolt 36 and reduces or prevents burrs at the lead-in face 28 during threading of the bolt 36 into the self-threading or self-tapping nut 20. As described further below, the volumetric relation between the recesses 34 and the annulus 42 defined between the minor and major diameters d₁ and d₂ define the amount or degree of filling of the recesses 34 during threading of the male fastener element 36 in the pierced self-threading bore 22 and therefore the female thread formed in the self-threading or tapping female fastener element of this invention.

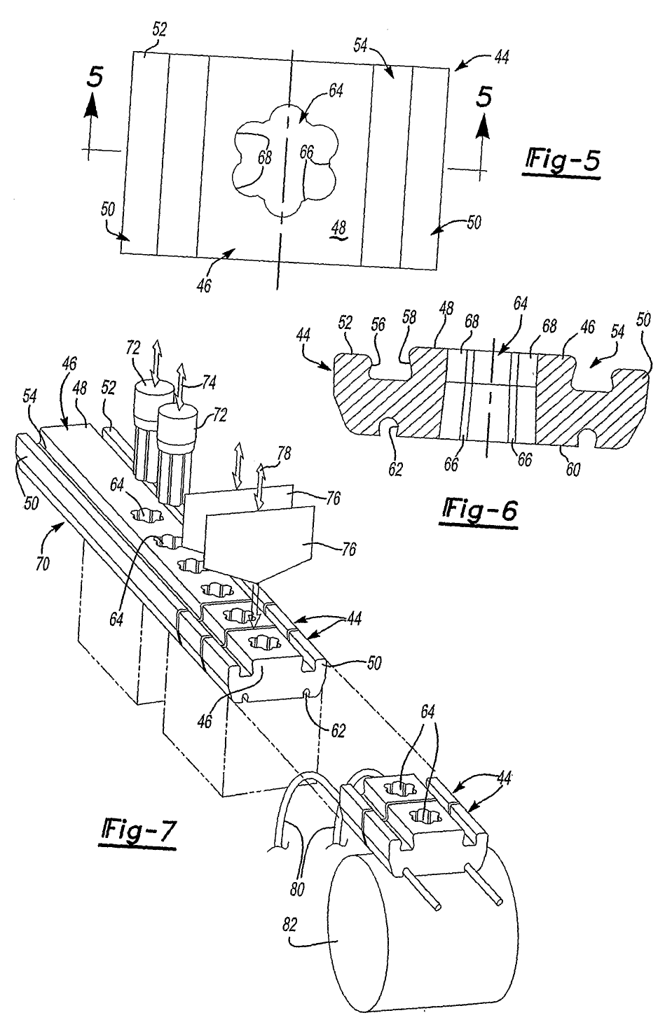

FIGS. 5 and 6 illustrate an alternative embodiment of a female fastener element 44 of this invention, wherein the female fastener element is a self-attaching nut which may be utilized as a pierce or clinch nut as disclosed, for example, in the above-referenced U.S. Pat. No. 3,648,747. The disclosed embodiment of the female fastener element 44 includes a central pilot portion 46 having an end face 48, flange portions 50 on opposed sides of the pilot portion 46 each having an end face 52 which are preferably but not necessarily spaced below the plane of the end face 48 of the pilot portion and grooves 54 defined in the flange portions 50. In the disclosed embodiment, the grooves 54 are referred to by those skilled in this art as “re-entrant” grooves because the inner and outer groove walls, 56 and 58 respectively, are inclined inwardly toward each other providing improved retention of the female fastener element on a panel (not shown) following installation. One or both side walls 56 and 58 are inclined inwardly. The female fastener element 44 further includes a back face 60 having grooves 62 for receipt of frangible connector elements as disclosed for example in the above-referenced U.S. Pat. No. 3,711,931.

As will be understood by those skilled in this art, the cross-sectional configuration of the female fastener element 44 shown in FIG. 6 may be formed by rolling a metal wire section in a rolling mill in a continuous operation. The female fastener element 44 shown in FIGS. 5 and 6 further includes a configured self-tapping pierced bore 64 including a generally cylindrical internal surface or circumferentially spaced surfaces 66 having equally circumferentially spaced concave recesses 68 as described above with regard to FIGS. 1 to 3, wherein the generally cylindrical surfaces 66 are frustoconical adjacent the back face 60 providing an enlarged lead-in opening for receipt of a male threaded fastener element as also described above.

FIG. 7 illustrates a method of forming a continuous strip of female fasteners 44 shown in FIGS. 5 and 6, wherein a plurality of female fastener elements 44 are reconnected or interconnected in a continuous strip by frangible connector elements 80 as disclosed in the above-referenced U.S. Pat. No. 3,711,931. The method of this invention thus begins with a continuous nut strip 70 having a desired cross-section of the female fasteners to be formed, such as the self-attaching female fastener element 44 shown in FIGS. 5 and 6, including a continuous rolled central pilot portion 46 having an end face 48, flange portions 50 on opposed sides of the pilot portion 46 each having an end face 52 and re-entrant grooves 54 in the flange portions as described above. The method then includes piercing the configured bore 64 of this invention shown in FIGS. 5 and 6 utilizing conventional piercing tools 72. In one preferred embodiment, two configured bores 64 are simultaneously pierced in the continuous strip 70 as shown in FIG. 7. As shown by arrows 74, the piercing tools 72 reciprocate as the strip is momentarily halted for piercing the configured self-threading bores 64. The strip is simultaneously chopped or cut-off by blades 76, separating the continuous strip 70 into discreet fastener elements 44 as shown in FIGS. 5 and 6. That is, the blades reciprocate as shown by arrows as the piercing tools 72 pierce the configured self-tapping bores or openings 64. The self-attaching fastener elements 44 may now be collected in bulk and utilized for attachment to a panel as described in the above-referenced U.S. patents.

Alternatively, the orientation of the fastener elements 44 may be maintained and the fastener elements interconnected in a continuous strip for feeding to an installation head as disclosed in the above-referenced U.S. Pat. No. 3,711,931, wherein the fastener elements 44 are interconnected by frangible connector elements 80 which are rolled and knurled by roller 82 into the grooves 62 as shown in FIG. 7 and described in more detail in the above-referenced U.S. patent. The method of forming a continuous strip of female fasteners shown in FIG. 7 thus has the additional advantage that the female fastener elements 44 may be interconnected in a continuous strip and maintained in the same orientation as the original nut strip 70, further reducing the cost of manufacture of the female fastener elements. That is, the female fastener elements do not have to be taken off line following chopping of the strip for tapping because the self-threading or self-tapping bores 64 eliminate the need for tapping, but the method of this invention also eliminates the requirement for aligning the fastener elements following tapping for attachment in a continuous strip.

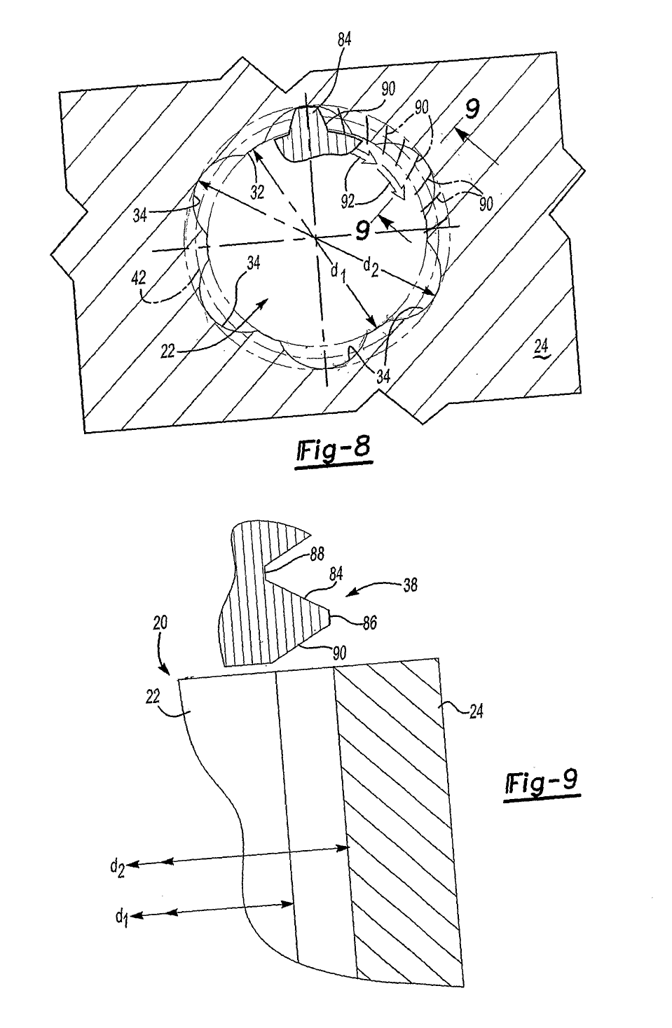

FIGS. 8 to 11 schematically illustrate the formation of a substantially continuous spiral female thread in the pierced configured bore 22 in FIGS. 1 to 3 and 64 in FIGS. 5 and 6 utilizing a conventional male fastener element as shown, for example, at 36 in FIG. 4. The reference numbers from FIGS. 1 to 4 are for description purposes only. As will be understood, the threaded shank 38 of a male fastener element includes a spiral thread 84 which conventionally includes a truncated crest portion 86 and a truncated root portion 88 as shown in FIGS. 4 and 9. In FIG. 8, the spiral male thread 84 of the male fastener has been turned ninety degrees to schematically illustrate the formation of the spiral female thread in the pierced bore of the female fastener element. However, as will be understood, the male spiral thread 84 is in fact deforming metal in the self-threading or self-tapping bore 22 radially and axially as the spiral male threaded shank is threaded into the configured self-threading or self-tapping bore 22.

As the male threaded shank 38 is threaded into the self-threading bore 22, the leading flank 90 of the spiral thread 84 deforms the cylindrical portions 32 between the recesses 34 into the recesses as shown by FIG. 8 and arrows 92. As will be understood, however, the cylindrical portions 32 are deformed axially and radially. However, FIG. 8 illustrates the preferred volumetric relation between the spiral male thread 38 and the configured self-tapping bore 22.

As shown and described above, the internal minor diameter d₁ of the internal cylindrical surfaces 32 is approximately equal to but slightly greater than the minor diameter D₂ of the threaded shank 38 and the major diameter d₂ measured between the radial outer surfaces of opposed recesses 34 is approximately equal to but preferably slightly greater than the major diameter D₁ of the threaded shank 38 as shown in FIG. 4. Thus, as the leading flank 90 of the male thread sweeps across or through the cylindrical portions 32, metal is deformed axially and radially in FIG. 8 into the recesses 34 as shown in FIG. 8. In a preferred embodiment, the “total volume” of the recesses is approximately equal to an annulus 42 defined by or between the minor and major diameters, d₁ and d₂, respectively, less the total volume of the recesses 32, such that the volume of the cylindrical portions 32 of the annulus 42 is approximately equal to but slightly less than the volume of the recesses. A substantially continuous female spiral thread is then formed in the configured bore 22 of the female fastener element which is substantially a mirror image of the spirally threaded male fastener 38.

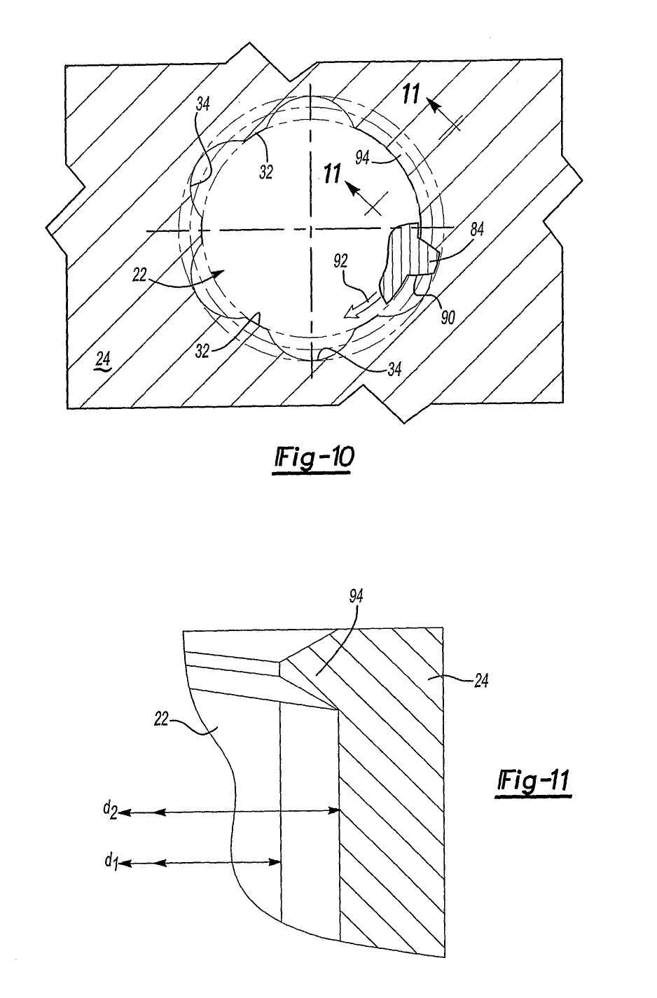

FIGS. 10 and 11 illustrate a further progression of the spirally threaded shank 38 into the configured bore, wherein a more substantially complete female thread 94 shown in FIG. 11 has been formed in the self-threading or self-tapping female bore 22 as the spiral thread 84 is threaded into the bore 22. As set forth above, however, the volume of the cylindrical portions 32 of the annulus 42 should be slightly less than the total volume of the recesses 34 to prevent binding of the male fastener element in the self-threading bore during threading. Experimentation has established that the volume of the annulus 42 between the recesses 34 should preferably be between eighty and ninety-five percent of the total volume of the recesses, providing a substantially fully formed spiral female thread, most preferably about ninety percent.

As will now be understood, the substantially continuous spiral female thread 94 formed in the bore 22 of the female fastener element is in substantially line-to-line contact with the male thread 84 of the male fastener element 36 which forms the female thread. Thus, the spiral female thread formed by the male threaded element also provides prevailing torque. For example, an M6 nut having a pierced self-tapping bore had a prevailing torque of 0.45 Nm following first removal and a prevailing torque of 0.3 Nm following the fifth removal of the nut from the male fastener element. The prevailing torque of the female fastener element is an important feature of the self-threading or self-tapping female fastener element of this invention because it provides substantially zero clearance. That is, the female fastener element will not loosen on a stud or screw under vibrational and other loads. The preferred shape and number of recesses is believed to be dependent upon the size of the nut. For an M6 nut, it was found that six cylindrical recesses are preferred because the desired volumetric relation between the recesses and the cylindrical surfaces can be achieved with six cylindrical recesses in an M6 nut. However, it is also believed that other shapes of recesses may be utilized to achieve the desired volumetric relationship in larger female fastener elements, particularly for larger female fasteners, including arcuate or even generally rectangular recesses, wherein the corners are arcuate.

As will be understood by those skilled in this art, various modifications may be made to the self-threading or self-tapping female fastener element and method of this invention. As set forth above, the self-threading bore may be utilized with any female fastener element including conventional nuts as shown in FIGS. 1 to 3 or specialized female fastener elements, including self-attaching female fastener elements such as pierce, clinch and weld nuts. The material selected for the self-attaching female fastener element will depend upon the application; however, steel having a Rockwell b hardness of between fifty to seventy has been found particularly suitable. The method of this invention may also be utilized to form a self-threading or self-tapping self-attaching female fastener element as disclosed in the above-referenced U.S. Pat. Nos. 3,775,791 and 3,999,659, wherein the self-attaching female fastener elements are retained in an integral strip including carrier portions on opposed sides of the pilot portion which also function as flange portions following installation. The configuration of the self-attaching fastener element will also depend upon the application and the panel retention grooves may also be located in the side faces of the pilot portion adjacent the flange portion as disclosed, for example, in the above-referenced U.S. Pat. No. 3,187,796.

The self-threading female fastener elements of this invention thereby eliminate threading or tapping of the bore of a female fastener element, including bulk handling and cleaning of chips, burrs and cutting oil, significantly reducing the cost and increasing production. The self-threading female fastener elements of this invention also provide prevailing torque eliminating loosening of the female fastener element under vibrational and other loads. Having described preferred embodiments of the self-threading female fastener elements and method of this invention, the invention is now claimed as follows.

1. A female fastener element having a self-threading bore for threaded receipt of a conventional spirally threaded male fastener element, comprising:
a metal body portion having a configured bore therethrough, said configured bore including a generally cylindrical internal surface having an internal diameter approximately equal to a minor diameter of said spirally threaded male fastener element and a plurality of circumferentially spaced concave recesses in said cylindrical internal surface having a total volume approximately equal to an annulus defined by a major diameter of said configured bore measured between a radial outer surface of opposed recesses and an internal diameter of said cylindrical surface less said total volume of said recesses, whereby threading of said spirally threaded male fastener element into said bore deforms metal from said generally cylindrical surface into said recesses forming a substantially continuous female thread in said bore.

2. The female fastener element as defined in claim 1, wherein said concave recesses each include a generally cylindrical internal surface.

3. The female fastener element as defined in claim 1, wherein said generally cylindrical internal surface of said bore includes an inlet portion receiving said male fastener element having a greater internal diameter than an intermediate portion of said bore.

4. The female fastener element as defined in claim 2, wherein said inlet portion is frustoconical having a major internal diameter greater than said intermediate portion of said bore.

5. The female fastener element as defined in claim 1, wherein said major diameter of said bore is approximately equal to a major diameter of said spirally threaded male fastener element.

6. A female fastener element having a self-threading bore for receipt of a conventional spirally threaded male fastener element, said female fastener element including a metal body portion having a configured bore therethrough, said configured bore including a generally cylindrical internal surface having a diameter greater than a major diameter of said spirally threaded male fastener element and a plurality of spaced generally arcuate concave recesses, whereby threading of said spirally threaded male fastener element into said bore deforms metal from said generally cylindrical surface to said spaced recesses forming a substantially continuous spiral female thread in said bore.

7. The female fastener element as defined in claim 6, wherein said generally cylindrical internal surface of said bore includes an inlet portion receiving said male fastener element having a greater internal diameter than an intermediate portion of said bore.

8. The female fastener element as defined in claim 7, wherein said generally cylindrical internal surface in said inlet portion is frustoconical having a major diameter greater than an internal diameter of said intermediate portion.

9. The female fastener element as defined in claim 6, wherein said generally cylindrical surface has an internal diameter approximately equal to a minor diameter of said spirally threaded male fastener element.

10. The female fastener element as defined in claim 9, wherein said bore has a major diameter measured between opposed said generally cylindrical recesses approximately equal to a major diameter of said spirally threaded male fastener element.

11. The female fastener element as defined in claim 6, wherein a total volume of said plurality of spaced generally cylindrical recesses is approximately equal to a volume of an annulus defined by a major diameter measured between a radial outer surface of opposed generally cylindrical recesses and a diameter of said generally cylindrical surface less said total volume of said recesses.

12. A threading female fastener element having a configured self-threading bore for receipt of a conventional spirally threaded male fastener element, said female fastener element including a metal body portion having a configured bore therethrough, said configured bore including a generally cylindrical internal surface having an internal diameter generally equal to a minor diameter of said spirally thread male fastener element including a frustoconical inlet portion and a cylindrical outlet portion, and said generally cylindrical internal surface including a plurality of spaced concave arcuate recesses having a total volume approximately equal to an annulus defined by a major diameter of said configured bore measured between a radial outer surface of opposed concave arcuate recesses and a diameter of said generally cylindrical surface less said total volume of said recesses, whereby threading of said spirally threaded male fastener element into said inlet portion of said bore deforms metal from said generally cylindrical surface into said recesses forming a substantially continuous female thread in said bore.

13. The female fastener element as defined in claim 12, wherein said major diameter of said bore measured between said radial outer surface of opposed recesses is generally equal to a major diameter of said spirally threaded male fastener element.

14. A method of forming a continuous strip of self-attaching female fastener elements, said method comprising the following steps:
rolling a metal strip having a cross-section of said female fastener elements including a continuous pilot portion having an end face and continuous flange portions on opposed sides of continuous pilot portion; and
piercing a self-threading bore through said end face of said pilot portion including a generally cylindrical internal surface and a plurality of circumferentially spaced concave recesses in said cylindrical surface having a total volume approximately equal to an annulus defined by a major diameter of said bore measured between a radial outer surface of opposed said recesses and an internal diameter of said generally cylindrical surface less said total volume of said spaced recesses, whereby threading a spirally threaded male fastener element into said bore having a major diameter greater than said internal diameter of said cylindrical surface deforms metal into said recesses forming a substantially continuous female thread in said bore.

15. The method of forming a continuous strip of self-attaching female fastener elements as defined in claim 14, wherein said method includes severing said strip and forming discreet self-attaching female fastener elements having a self-threading bore.

16. The method of forming a continuous strip of self-attaching female fastener elements as defined in claim 15, wherein said method includes interconnecting said discreet self-attaching female fastener elements with a frangible connector element without reorienting said fastener elements.

17. The method of forming a continuous strip of self-attaching females fastener elements as defined in claim 14, wherein said method includes piercing said bore through said end face of said pilot portion and forming a frustoconical opening through a back face of said strip opposite said end face.

18. The method of forming a continuous strip of self-attaching female fastener elements as defined in claim 14, wherein said method includes piercing said bore through said pilot portion having substantially cylindrical spaced recesses in said generally cylindrical internal surface.
